(19) United States
(12) Patent Application Publication
(10) Pub. No.: US 2017/0024691 A1
(43) Pub. Date: Jan. 26, 2017

(54) SYSTEM AND METHOD FOR EFFICIENT HOME DELIVERY OF PERISHABLES

(71) Applicant: Daniel E. O'Brien, Peorla Heights, IL (US)

(72) Inventor: Daniel E. O'Brien, Peorla Heights, IL (US)

(21) Appl. No.: 15/136,516

(22) Filed: Apr. 22, 2016

Related U.S. Application Data
(60) Provisional application No. 62/151,311, filed on Apr. 22, 2015.

(51) Int. Cl. G06Q 10/08

(52) U.S. Cl. CPC G06Q 10/0832

(57) ABSTRACT

A system and method are provided for the delivery of perishable products such as dairy products wherein the system combines a wholesale distribution network with a residential delivery network. A delivery hub receives perishable products from a distributor and stores and packages same for downstream delivery to the customers subscribing to the system. The system incorporates the use of low cost operational components and a low overhead, delivery-only storefront or facility. Additionally, two primary low cost operational components would be utilized, namely a low-cost delivery vehicle 15, such as an electric passenger sedan, and low-cost, long-lasting delivery packages 16, such as iceless cooler cases. The cooler cases are preferably provided as iceless cases that incorporate a gel technology that is pre-cooled at the storefront by a refrigeration unit wherein the cases 16 and gel technology retain the low temperature for an extended cooling time for delivery.

### CROSS REFERENCE TO RELATED APPLICATIONS

This application asserts priority from U.S. provisional application Ser. No. 62/151,311, filed on Apr. 22, 2015, the disclosure of which is incorporated herein by reference in its entirety.

### FIELD OF THE INVENTION

The invention relates to a system and method for efficient home delivery of perishables.

### BACKGROUND OF THE INVENTION

A few interesting facts regarding the dairy industry facilitated the design of this inventive business model of the present invention. 52 billion pounds or 6 billion gallons of milk were sold during 2013 in the U.S. at an average price of $3.84 per gallon. This generated 23 billion dollars in sales. The average American drinks milk on 280 occasions per year, consuming 45 pounds or 5.2 gallons of milk per capita. In other words, 78% of the days in 2013, everyone drank milk. Prior to the 1960's, delivery service for dairy products was a routine part of life. As time progressed, the gas and transportation costs for this service rose. The refrigeration cost over long distances became less practical, especially with the advent of grocery and convenience stores. Changes in the packaging of milk from traditional glass to newer plastic containers decreased the need for rapid milk delivery before spoilage.

Dairy farms were also responsible for both the production and the delivery of the product. Dairies were faced with decreasing profitability in the delivery arm of their business. Focus moved towards consolidating milk production in order to improve sales. Marketing efforts then shifted from the individual consumer to the larger grocery stores. Despite the mass appeal of a personalized delivery service, the expenses became too great to sustain such service in light of increased production and transportation costs. After evaluating these factors, it is apparent that the milk delivery service industry declined primarily due to external pressures rather than from a true decrease in public demand; the more typical causative factor for business failure. The demand for consumption of milk as a product has remained remarkably stable for decades, with sales actually increasing in many markets. Newer products such as Greek yogurt have dramatically increased dairy sales.

It is the goal of the present invention to utilize new technological advances to modernize a delivery business that had enjoyed success for decades, and to reinvent the milk delivery business and bring back a modern day milkman. Improved efficiency and cost savings can be achieved by eliminating the problems that caused the industry's prior demise.

### SUMMARY OF THE INVENTION

Advancing technology and increased methods of communication have placed more demands on the free time of the typical American. Regardless of these modern advances, most people are still frequently faced with the duty of “picking up milk on the way home.” There is even a website named “rememberthemilk.com”; an online to-do list for task management assistance. The present inventive business system provides the marketplace a service that eliminates such routine time consumption as well as the annoyance of the routine mental task.

Large retail stores have been successful at consolidating the sale of many types of goods; however the sheer size of these stores has made this commonplace trip somewhat difficult. Consider the time spent by a customer when parking in a massive parking lot, walking hundreds of yards to pick up a one gallon container of milk—typically located at the back of the store then finally waiting in a long line to check out. This situation inevitably occurs during the 6 pm rush hour. Conversely, the success of online stores such as Amazon has made convenient home delivery more commonplace. This type of commerce has started to normalize the purchasing of everyday items that have historically been purchased at physical storefronts.

To date, the perishable nature of dairy products has precluded the direct home shipping of these goods. Timing the delivery of perishable goods is still essential for freshness. This continues to require a well-planned delivery network originating from local distribution hubs. Large dairy cooperatives have succeeded in centralizing regional delivery hubs for wholesale milk delivery to retail stores. The present business model solves prior efficiency and cost issues by combining this existing wholesale distribution network with a new residential delivery network.

The business model of the present invention will give customers valuable time savings by offering a reliable home delivery service. The average customer has a very set routine for purchasing certain grocery items. They also have a pattern of purchasing more varied, random items to consume, hence bringing interest or spice to their daily diet. Routine purchases include dairy items, milk, cheese, yogurt; while varied items may be types of meat, vegetables, different canned goods, etc. The desire for variety will always prompt a customer to periodically visit the grocery store. By nature this leads to hesitancy committing to delivery services that offer complete grocery delivery. Most individuals want to feel the fruit, see the cut of meat, or pick out special items for special occasions. Milk, cheese, and yogurt however, are fixed, known items that customers routinely purchase by habit with little variance. Many people view the task of purchasing weekly milk as an annoyance that leads to 4-6 extra trips a month. Delivery would eliminate these extra trips, and decrease the need for frequent grocery store trips.

The historical expenses of dairy delivery can be mitigated by creating a service that incorporates the use of low cost operational components and a low overhead, delivery-only storefront. Two primary low cost operational components would be utilized: a low-cost delivery vehicle, such as the electric passenger sedan, and low-cost, long-lasting delivery packages, such as iceless cooler cases. The electric car would allow for maximal fuel efficiency, with current cars approaching 120 mpg equivalent. The iceless cases would incorporate a gel technology allowing for extended cooling time, averaging 10 hours without refrigeration.

To further reduce costs and improve efficiency, the business would ideally be a direct distributor of dairy products to the customer without affiliation. The business is not affiliated with the dairy farm that produced the milk, the grocery store, nor any grocery delivery services. The business would limit their product offerings to staple items that are needed on a routine, typically weekly basis. Limiting product offerings will maintain brand identity and prevent the expenses associated with processing orders from other types of goods and their associated businesses. More varied grocery items would require a myriad of different transport methods and serve only to dilute brand identity. Additional benefit for the customer would be achieved by the ability to offer select, local staple items for online sale. In contrast to a pure grocery store delivery service, this unique delivery solution allows for producers of less accessible “farm to table” products to enjoy a much larger geographic delivery market.

Over the past few years, electric vehicles have become increasingly affordable and available due, in part, to a marked increase in mass production of electric vehicles. For the first time in history, this currently allows for the purchase of a used electric vehicle, making previously expensive electric cars much more affordable. For example, the electric 2012 Chevy Volt -this vehicle is readily available for purchase at an average of $15,000 per vehicle. The concept of using a passenger sedan for milk delivery is much different than the traditional method of large, refrigerated trucks that were very costly to obtain ($40,000 per vehicle) as well as costly to maintain. Aside from reducing purchasing and maintenance costs, an electric sedan would markedly decrease fuel costs.

For example: Let us assume a delivery radius of 10 miles with average of 120 miles driven daily, equaling 30,000 miles per year with a gas price of $2.50/gallon.
1,500/year fuel cost—Refrigerated van at 10 mpg
$625/year fuel cost—Electric sedan at 120 mpg
$20,625 savings over a 3 year lifespan of the electric vehicle

If an electric vehicle such as the Chevy Volt was used, the cargo space would prove to be more than adequate for planning a 10-15 mile delivery range. Assuming 30-50 delivery stops per given morning or afternoon; the 10-15 mile delivery range would approach the maximum number of achievable deliveries regardless of the size of the vehicle. The Volt has 50.4 cu feet of cargo area. Each cooler case requires 0.66 cubic feet. This results in a maximum capacity of 75 cooler cases without requiring the vehicle to return to the distribution center.

The question of delivery refrigeration would preferably be addressed by the use of low cost, gel lined cooler cases; packaged at centrally located, small, low overhead storefronts. The 10 hour duration of cooling allows for drivers to complete morning delivery between 3 am-9 am and afternoon delivery between 10 am-4 pm. The morning customers (most retrieving their delivery before 9 am) would have until 1 pm-6 pm for continued safe cooling. The afternoon delivery customers would have until 8 pm-2 am for continued safe cooling. These cases would be exchanged at each delivery, at no cost to the customer.

To help further manage costs and efficiency, the business would preferably use low-cost storefronts as central delivery hubs. The storefront would have a walk in cooler for large volume product delivery, and a freezer that houses several thousand cooler cases. Each storefront would employ two staff; one receptionist and one employee responsible for the packaging of the dairy products. The space would be very economical, with an approximate size of 1500 square feet, thus minimizing rent and property taxes. The size and store design would create an easily reproducible template from which similar storefronts could quickly be placed in emerging markets. The storefront would contain a 15×20 foot walk-in cooler, a 40 cubic foot freezer, and a garage door for loading access.

Separate storefronts would be geographically located in population densities of 50-100,000 people per storefront. This population size equates to 15-30,000 households, giving a target market of 11,700-23,400 separate delivery addresses (assuming 78% milk consumption). If this delivery service proves successful in capturing at maximum 20% of these milk drinkers, then each store would service 2,340-4,680 customers. 5,000 customers would be the maximum capacity of the walk in cooler by means of product storage area, as well as the maximum capacity given the logistics of loading and unloading 8 delivery vehicles. Each driver would have a maximum capacity for 100-140 deliveries per day. This calculation is based upon the time spent loading and unloading the vehicles; the time spent delivering the cases, as well as the discussed physical limitation of the vehicle's carrying capacity. Given these parameters, 8 drivers could maximally deliver 1120 cases per day, 5600 per week.

Ideally, the storefront would be located in a building owned by the business, to further reduce costs and increase efficiency. For example, the building containing the delivery storefront could be a 5000 square foot structure that would have the appearance of a commonplace and affordable strip mall. The additional building space would contain one or more rental units adjacent to the delivery business. These additional spaces would be rented to other businesses. The purchase of such a building type would provide for the financial health of the delivery business by allowing the income obtained from the additional units to offset the rent costs of the primary delivery business.

Further efficiency and cost savings can be achieved by the use of an efficient, safe, user friendly website. Mobile devices have revolutionized the way we accomplish everyday tasks. Many people shop online and pay bills on mobile devices every day. This ease of use and convenience is becoming part of our way of life. An efficient website that is easily usable both on phones and tablet computers has become a business essential. This business asset is arguably more important than many other facets of a modern business enterprise.

Preferably, the website would be more than a consumer-facing asset, but would also act as the sales platform for the delivery business. The website could act as the ordering forum as well as the billing and collections platform. It would preferably have an emphasis on convenient: mobile use for ordering. As discussed, most people have a mental “to do” list. They think about these tasks at random times during the workday, at lunch or in the evening. Mobile use would allow for instant customer access when the person suddenly remembers that they need more milk or yogurt. This mobile connectivity also allows for prompt customer notification of a delivery as well as a means of providing an instant communication tool. This functionality would allow the customer to notify us of vacations or travel with a single click.

Orders online would preferably be transmitted thru a single unified web forum at http://www.merrymilkdelivery.com. The website would have the capability to group the name, address and order items for each day's delivery schedule. A label printer would then print that specific data for each customer on separate labels. The packager would then place the label on a cooler case that was just retrieved from the freezer. They would then enter the walk-in cooler, place the ordered items in the case as listed clearly on the label. When finished, they would set the completed order on a separate rack inside of the cooler in anticipation of the driver's pickup.

Online orders could then be coordinated with the delivery logistics process. During delivery, the driver would arrive in an electric vehicle such as the Chevy Volt. The back seats of the car would always be placed down for maximum carrying capacity. He would take the 30-50 cases and place them in the sedan. No other modifications would need to be done to the car. A magnetic logo would simply be placed on the sides of the car for advertising purposes. The driver would have a tablet computer (as would all employees) that displayed for him an integrated mapping system. This system will be based on the company website. It will take the orders that were placed for that morning and plot the customer's addresses on a GPS enabled map. It will do so in a fashion that allows for the most efficient delivery route, thus maximizing the driver's time and eliminating navigation errors.

The labels placed on each case would clearly identify which order to deliver at which address. At each home the driver would exchange the new case for the prior empty case from the last delivery. The customer only has one responsibility in the delivery process. They would be instructed to place the empty case outside the door for pickup on delivery day. If they forget this on four consecutive occasions, the customer would then be charged a fee per case. The fee would be refundable when the empty cases returned.

When the exchange is made, the driver marks the delivery complete on the tablet. This immediately would notify the customer of the delivery arrival via a method of their choice, text message or email. No notification would be sent if the customer did not desire notification. The driver finally returns to the storefront with the empty cases from the morning delivery. He cleans the cases in a sink using disinfectant and then places them into the freezer for the following day's use. Next, he picks up his delivery cases for his afternoon route and repeats the process.

Ideally, the business would utilize independent contractors or self-managed delivery drivers. The driver would be in possession of the vehicle and also responsible for the maintenance of the vehicle. The driver would be required to charge the vehicle overnight in a garage, accomplished by simply plugging the car into a regular household outlet. This personal use of the delivery car will be part of the compensation package for the driver. Expectations regarding the car maintenance and regular charging will be clearly defined before the driver's employment. This system will allow the business to have flexibility to rapidly increase the number of drivers and delivery vehicles without requiring the purchase of additional real estate for garage space.

For nearly all marketed electric sedans, overnight charging to maximum battery capacity is achieved by plugging the vehicle into a household outlet overnight. Brief battery recharging would be preferable for an additional one hour at midday, but not required. For example in one hour's time, the Chevy Volt achieves a 30% recharge on a 220 volt rapid charger. This would make the Volt's range meet the requirement of a 120 mile daily delivery route, using only electric power. A rapid charger can easily be installed at the delivery storefronts at minimal expense. The additional benefit of electric sedan engines is their ability to far exceed the typical mileage lifespan of gasoline engines. This makes the additional miles placed on the vehicles by the driver's personal use a minor cost factor.

The elimination of production cost affected by the separation of the dairy farm from the delivery company will allow the marketing of dairy products from well-established dairy farms, such as items from Prairie Farms distribution centers. This gives the customer brand identity and familiarity with the product being delivered. This structure will clearly define the role of the present system as simply a service for the delivery of products—products that the consumer likely already purchases.

The model for milk delivery that is still in existence is largely comprised of niche dairy farms that offer milk originating from their own dairy's production. This milk is typically contained in glass bottles that require cleansing and reuse, and is associated with transportation and storage in large coolers on refrigerated trucks. This model markets to a rather small percentage of dairy consumers who are willing to pay considerably extra for special milk and special service.

Ideally, the business would market dairy products that are already mass consumed. By purchasing at the wholesale price, the business would be able to match the price that dairy products are offered to the consumer in the local stores. This point is crucial, and would be the primary focus of advertising efforts to the consumer. The ad campaign would emphasize “Same Products, Same Prices, just Delivered™” and “Get Merry Milk Delivery at Grocery Store Price™”. In a similar fashion, this model supports the wholesale purchasing of items from local growers, which then can be offered to the consumer at the same price found in the local Farmer's Market.

The business would preferably utilize and gain marketing power by employing wholesale purchasing given the secondary ability to use established marketing material from the wholesaler. This relationship would clearly be mutually beneficial if delivery sales increased. This approach would target the 90% of the population that does not drink milk from specialty dairy films (Oberweiss or Schwann's) who still offer a more expensive dairy delivery service. These dairies would likely not see a significant change in sales volume. Such established customer bases would still likely prefer to drink milk that did not originate from the wholesaler.

Overhead cost is also minimized with wholesale purchasing. Due to the extensive delivery network of the regional dairy distributor, the business could have daily wholesale delivery of the dairy products at the storefront. This allows the business to house the product for a short period of time, and then deliver the entirety of that product directly to the consumer.

This achievement: will be possible due to the utility of an efficient Internet based ordering system. The system will allow the business to collate the orders from one workday, and then adjust the wholesale purchase order accordingly for the next day's wholesale delivery. This reduces wastage of product and allows for purchasing based on exact consumer demand.

No products would be sold at the brick and mortar packaging centers of the inventive system. As such, minimal modifications and embellishments would be needed to the property. These costs would otherwise be required for a physical storefront that receives prospective customers. All customer service for the delivery service would be Internet based. No published phone number would be given; however, a receptionist would oversee the management of the online customer support. They would also physically staff the storefront during business hours and help with the coordination in loading the delivery cars.

The initial model of the subscription service would preferably include only two options: once or twice weekly delivery. A subscription will be required to become a customer, but it could easily be cancelled at any time without any penalty. The subscription options will not require a minimum dollar amount per order. To enroll however, the customer should have at least one reoccurring item ordered, which could be for any dollar amount. For example, a customer may only order a single half gallon of milk weekly; they would have the option to simply get this product every week, or they could choose to add items intermittently or repeatedly. They could also change the identity of the reoccurring item at any time.

Preferably, to ensure purpose of this service of fulfilling reoccurring needs for the same items, the business would not have options for one-time deliveries or twice a month delivery. By limiting subscription options, the business will create long term relationships with customers; form a habit in the mind of the customer; as well as reduce the number of one-time or less committed customers. Such one time or short duration clients would not have the opportunity to experience the convenience of routine delivery. They would be less likely to form a habit of relying on the inventive service and subsequently would create more expense than benefit in the long term. Once the business is established or if new needs are identified, then additional types of subscriptions could be offered. The mobile device and web ordering platform would allow for rapid modifications of these orders giving added convenience. For instance, even the day before a scheduled delivery, the customer could alter, amend, or make one time orders as desired.

Other objects and purposes of the invention, and variations thereof, will be apparent upon reading the following specification and inspecting the accompanying drawings.

### BRIEF DESCRIPTION OF THE DRAWINGS

FIG. 1 diagrammatically illustrates the system of the present invention.

FIG. 2 is a cover of a representative brochure for the system and method of the present invention.

FIG. 3 is a next page of the representative brochure.

FIG. 4 is a further page of the representative brochure.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof Said terminology will include the words specifically mentioned, derivatives thereof, and words of similar import.

### DETAILED DESCRIPTION

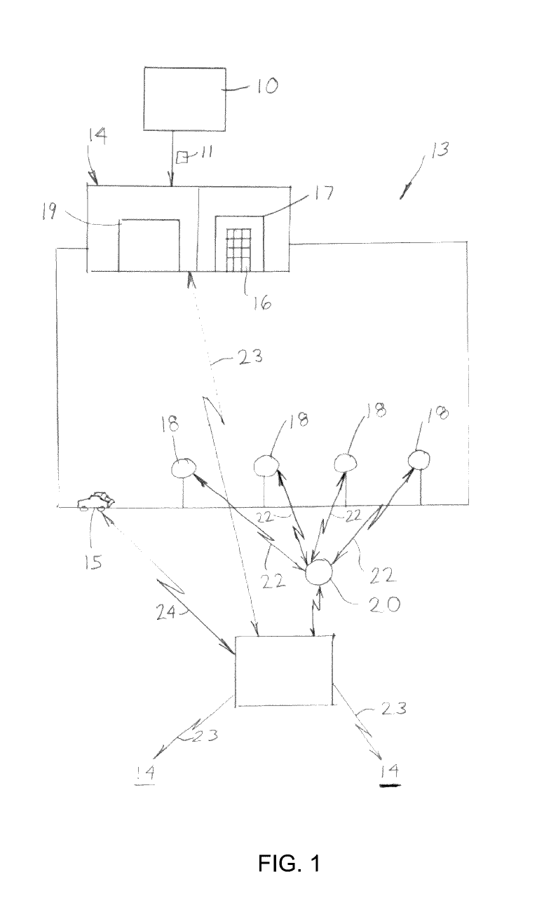

Referring to FIG. 1, the invention relates to the delivery of various products 11 such as perishable products like dairy products (which are shown as representative blocks) wherein the perishable nature of dairy products and other products has generally precluded the direct shipping of these goods to homes and other residence addresses. For conventional methods, a well-planned delivery network originates from local distribution hubs, wherein large dairy cooperatives may supply centralizing regional delivery hubs for wholesale milk delivery to retail stores. The present system of the invention combines this existing wholesale distribution network with a new residential delivery network, wherein FIG. 1 diagrammatically illustrates a regional product distributor or wholesale distributor 10, which is supplied by producers, and a representative delivery hub defined by a storefront or facility 14, which receives perishable products 11 from the distributor 10 and stores and packages same for downstream delivery to the customers subscribing to the system 13 of the present invention. It will be understood that the distributor 10 may alternatively be a product producer of such products 11, such as local growers wherein this type of distributor 10 may both produce the products 11 and deliver same to the storefront 14.

The business model of the present invention will give customers valuable time savings by offering a reliable delivery service for purchases and more specifically, routine purchases of perishable products 11 which may include dairy items, milk, cheese, and yogurt. The historical expenses of home delivery is mitigated by the inventive service 13 that incorporates the use of low cost operational components and the low overhead, delivery-only storefront or facility 14, which is diagrammatically shown in FIG. 1. Additionally, two primary low cost operational components would be utilized, namely a low-cost delivery vehicle 15, such as the electric passenger sedan, and low-cost, long-lasting delivery packages 16, such as iceless cooler cases. Using the electric car as the delivery vehicle 15 would allow for maximal fuel efficiency, with current cars approaching 120 mpg equivalent. The cooler cases 16 are preferably provided as iceless cases that incorporate a gel technology that is pre-cooled at the storefront 14 by a refrigeration unit 17 to a low temperature wherein the cases 16 and gel technology retain the low temperature for an extended cooling time, preferably averaging 10 hours without refrigeration after the cases 16 are removed from the refrigeration unit 17 for delivery.

For example, the delivery vehicle 15 may be an electric 2012 Chevy Volt. The concept of using a passenger sedan for milk delivery is much different than the use of large, refrigerated trucks that were very costly to obtain as well as costly to maintain. A typical refrigerated truck was more costly to purchase due to the larger size and associated refrigeration equipment installed on the vehicle. Due to the additional equipment, size and weight, the maintenance costs are also greater than an electric vehicle. Aside from reducing purchasing and maintenance costs, an electric sedan would markedly decrease fuel costs.

The system accommodates a limited range for a delivery vehicle 15 such as an electric passenger sedan which may have a delivery radius of 10 miles with an average of 120 miles driven daily. The cargo space of such vehicle 15 would be more than adequate for planning a 10-15 mile delivery range. The system includes a delivery area that is a function of the operational range of the vehicle, its cargo capacity, and likely, the local consumption of perishable products within that area. Assuming 30-50 delivery stops per given morning or afternoon delivery trip, the 10-15 mile delivery range would approach the maximum number of achievable deliveries regardless of the size of the vehicle. One commercially available electric vehicle 15 has 50.4 cubic feet of cargo area, wherein each cooler case may only require 0.66 cubic feet. This results in a maximum capacity of 75 cooler cases without requiring the vehicle 15 to return to the storefront 14. The delivery ranges or routes might become smaller as the population density in that area is greater, or if a smaller, more efficient vehicle is used. Also, the range or routes may become larger for opposite reasons.

The question of delivery refrigeration would preferably be addressed by the use of low cost, gel lined cooler cases 16 which are pre-cooled by a cooling source such as a refrigeration unit 17 at the storefront 14. The refrigeration unit 17 preferably is a freezer. The cases 16 also might have alternate cooling sources such as built-in refrigeration units wherein the cooler is a low-voltage plug-in cooler case. The cooled cases 16 are packaged at the storefront 14 which is centrally located in a target market or distribution territory and are small and have low overhead. Different types of gel and cooler temperatures might extend the time period over which the temperature is suitably low so as to allow for delivery by the vehicle 15 and recovery by the customer. The characteristics of the cases 16 and the gel used therein can be developed considering the minimum time period over which the case 16 must be kept at a suitable temperature, the temperature at which the product 11 must be maintained, the preferred temperature of the cases 16, and cost, wherein different gels and cooler materials and constructions may be suitable and cost effective, while others may not. The 10 hour duration of cooling allows for drivers to complete delivery to various delivery addresses 18, which may be residences, during one of a plurality of delivery times, which might be morning delivery between 3 am-9 am and afternoon delivery between 10 am-4 pm. The morning customers (most retrieving their delivery before 9 am) would have until 1 pm-6 pm for continued safe cooling. The afternoon delivery customers would have until 8 pm-2 am for continued safe cooling. These cases 16 would be exchanged at each delivery, at no cost to the customer.

To help further manage costs and efficiency, the business would preferably use the low-cost storefront 14 as the central delivery hub for a distribution territory. The storefront 14 would have a cooler, which preferably is a walk in cooler 19 for large volume product delivery from producers of product 11, and the refrigeration unit 17 preferably operates as a freezer that houses several thousand cooler cases 16. Each storefront 14 preferably would employ at least one employee responsible for manually packaging the products 11 into the cases 16. While manual packaging of the cases 16 is one option, packaging of the cases 16 also might be automated.

Separate storefronts 14 would be geographically located in distribution territories preferably having population densities of about 50-100,000 people per storefront 14. This population size equates to 15-30,000 households, giving a target market of 11,700-23,400 separate delivery addresses or residences 18. Each storefront 14 may service 2,340-4,680 customers. 5,000 customers would be the maximum capacity of a 15 by 20 foot walk in cooler 19 by means of product storage area, as well as the maximum capacity given the logistics of loading and unloading eight delivery vehicles 16. Each driver and their vehicle 15 would have a maximum capacity for 100-140 deliveries per day. The size of the distribution territories may vary depending upon the population density, the model, type, number and size of the vehicles 15, the size of the storefront 14 and total capacity for storing products 11 and cases 16, and the mileage limitations of the vehicles 15 among other factors.

Further efficiency and cost savings can be achieved by the use of an efficient, safe, user friendly website 21 which is connected to the Internet or other communication system or network 20 and is accessible by customers through the Internet or other communication links 22 operated through the network 20. The website 21 may be accessed through various computer devices such as stationary devices including desktop computers, and mobile devices such as laptops, tablets and smartphones.

Preferably, the website 21 would act as the sales platform for the delivery business 13. The website could act as the ordering forum as well as the billing and collections platform. It would preferably have an emphasis on convenient, mobile use for ordering. Orders online would preferably be transmitted thru a single unified web forum on the web site 21 such as through the URL http://www.merrymilkdelivery.com. The website 21 would have the capability to group the name, address and order items for each day's delivery schedule, and would communicate with the storefront 14 through a communications link 23 which can be accessed through computer devices at the storefront 14 like tablets or the like. A label printer would then print that specific data for each customer and their order on separate labels. The packager at the storefront 14 would then place the label on a cooler case 16 that was just retrieved from the freezer 17. They would then enter the walk-in cooler 19, place the ordered items in the case 16 as listed clearly on the label. When finished, they would set the completed order on a separate rack inside of the cooler 19 in anticipation of the driver's pickup and loading in the delivery vehicle 15.

Online orders could then be coordinated with the delivery logistics process. During delivery, the driver would arrive in an electric vehicle 15. In a conventional electric vehicle 15, the back seats of the car would be placed down for maximum carrying capacity. The driver would take the 30-50 cases and place them in the sedan 16. No other modifications would need to be done to the vehicle. A magnetic logo would simply be placed on the side of the vehicle 15 for advertising purposes. Preferably, the driver would have a mobile device such as a tablet computer (as would all or some of the employees) that communicates through a communication link 24 to receive information from the web site 21 and the tablet would display an integrated mapping system showing a delivery route 25. This system will be based on the company website 21 and the associated computer system which may comprise various computer components such as a server, processors, storage media and other computer components controlling the website 21. The computer system will take the orders that were placed for that morning and plot the customer's addresses on a GPS enabled map. It will do so in a fashion that allows for the most efficient delivery route 25, thus maximizing the driver's time and eliminating navigation errors. In this regard, the system 13 may incorporate load-planning software to plan the route and calculate the timing of the deliveries.

The labels placed on each case 16 would clearly identify which order to deliver at which delivery address 18. At each address 18, the driver would exchange the new, loaded case 16 for the prior empty case 16 from the last delivery made at an earlier time. The customer only has one responsibility in the delivery process. They would be instructed to place the empty case 16 outside the door for pickup on delivery day. If they forget this on four consecutive occasions, the customer would then be charged a fee per case. The fee would be refundable when the empty case is returned.

When the exchange is made, the driver marks the delivery complete on the tablet which information is communicated through link 24 to the website 21 or the associated server operating such website. This action immediately would cause the computer system to notify the customer of the delivery arrival via a method of their choice, such as text message or email, made through a communication link such as link 22. No notification would be sent if the customer did not desire notification. The driver finally returns to the storefront 14 with the empty cases 16 from the morning delivery. He cleans the empty cases in a sink using disinfectant and then places them into the freezer 17 for the following day's use. Next, he picks up his filled delivery cases 16 for the afternoon route and repeats the process.

Overhead cost is minimized with wholesale purchasing. Due to the extensive delivery network of the regional dairy distributor 10, the system 13 could have daily wholesale delivery of the dairy products at the storefront 14. This allows the business to house the product 11 for a short period of time, and then deliver the entirety of that product 11 directly to the consumer.

This achievement will be possible due to the utility of an efficient Internet based ordering system. The system 13 will allow the storefront 14 to collate the orders from one workday, and then adjust the wholesale purchase order accordingly for the next day's wholesale delivery from the distributor 10. This reduces wastage of product and allows for purchasing based on exact consumer demand.

Preferably, no milk products would be sold at the brick and mortar packaging centers or storefronts 14 of the inventive system. All customer service for the delivery service would be Internet based.

The initial model of the subscription service would preferably include two options: once or twice weekly delivery, which is ordered through the web site 21. A subscription will be required to become a customer, but it could easily be cancelled at any time without any penalty. The subscription options will not require a minimum dollar amount per order. To enroll however, the customer should have at least one recurring item ordered, which could be for any dollar amount. For example, a customer may only order a single half gallon of milk weekly; they would have the option to simply get this product every week, or they could choose to add items intermittently or repeatedly. They could also change the identity of the reoccurring item at any time through the web site 21.

The mobile device and web ordering platform 21 would allow for rapid modifications of these orders giving added convenience. For instance, even the day before a scheduled delivery, the customer could alter, amend, or make one time orders as desired.

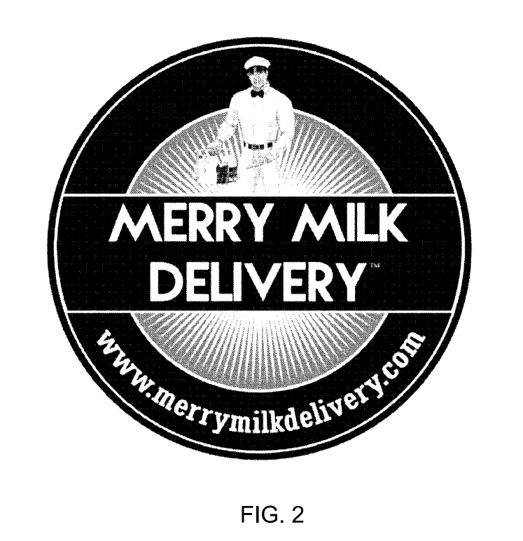

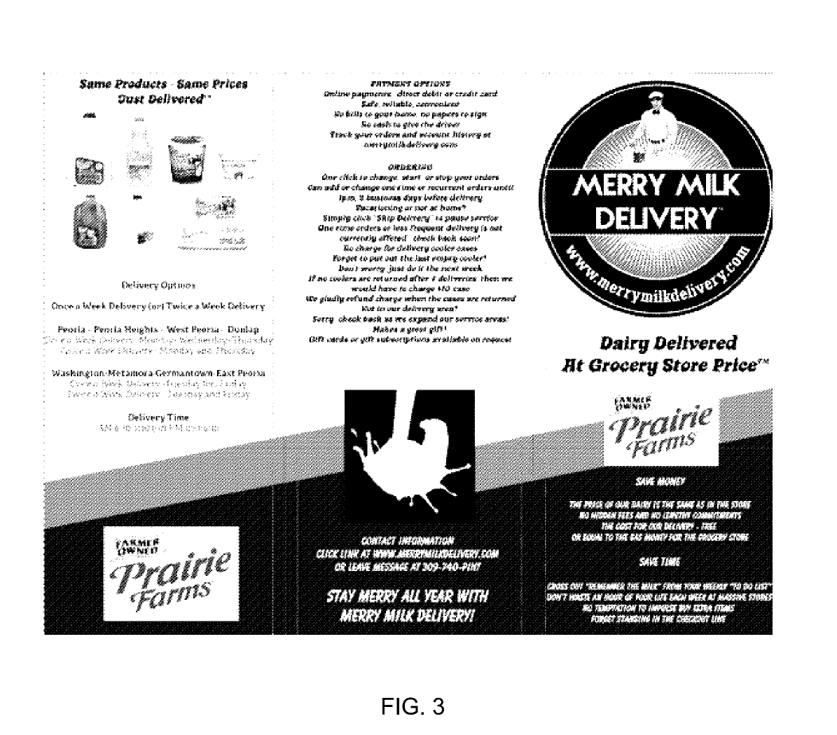

FIGS. 2-4 generally illustrate a sample brochure and information used in association with and describing features of the system 13 and method of the invention. As described herein relative to FIG. 3, the present invention provides customer-selected delivery options including once a week or twice a week delivery. For example, one geographic territory such as a first group of cities located close or contiguous to each other, might have the option of once a week delivery on a first subset of days in a week, such as Monday, Wednesday, or Thursday, or twice a week delivery on two of the first subset of days, such as Monday and Thursday. In a second geographic territory, such as a second group of cities located close or contiguous to each other, might have the option of once a week delivery on a second subset of days in a week, such as Tuesday or Friday, or twice a week delivery on two of the second subset of days, such as Tuesday and Friday. The first and second geographic territories can comprise the entirety of the target market or distribution territory for a particular storefront or delivery facility. The customer would select these options through the web site 21.

Further, the customer has the option of selecting from one or more available delivery times through the web site 21 as described above.

The online web site 21 provides payment options for online payments, which can include use of a direct debit card or credit card. This system is safe, reliable and convenient with no bills being sent to a customer's home and no papers to sign. With this system, there is no cash to give to the driver, and a customer can track orders and account history through the system web site.

The web site 21 operates to allow ordering with one click of a mouse or other computer input device which is operable to change, start or stop orders with one click. With the ordering system, the customer has the option to add or change one time or recurrent orders until a certain cutoff time before the delivery date, such as 1 pm, 2 days before delivery. If vacationing or not at home, the ordering system operated through the web site 21 allows a customer to simply click or activate the “skip delivery” option to pause service. However, one time orders or less frequent delivery from the options discussed above may not be currently offered by the delivery system and invite the web site visitors to “check back soon”.

The system 13 also provides that there is no charge for delivery cooler cases. If a customer forgets to put out the last empty cooler, the customer is encouraged to “do not worry” since they can just do it by the next week. However, if no coolers are returned after 4 deliveries, then the system would have to charge $10 US dollars or some other penalty charge or fee per case. The system 13 refunds the charge when the cases are returned.

The ordering system also determines if a potential customer is not in the system's delivery area and declines an order but invites the customer to check back to monitor if the service area is expanded. The system also may allow for gift cards and gift subscriptions which may be available on request.

With this system, the dairy products and other products 11 are delivered at grocery store prices. Preferably, the price of such products is the same as in the store with no hidden fees and no lengthy commitments. The cost of delivery is free or equal to the gas money which would be spent going to the grocery store or other store. This system saves time, and does not require reminders on a weekly to-do list. A customer does not need to waste an hour of time each week at massive stores; such that there is no temptation to impulse buy extra items and a customer can forget standing in the checkout lane.

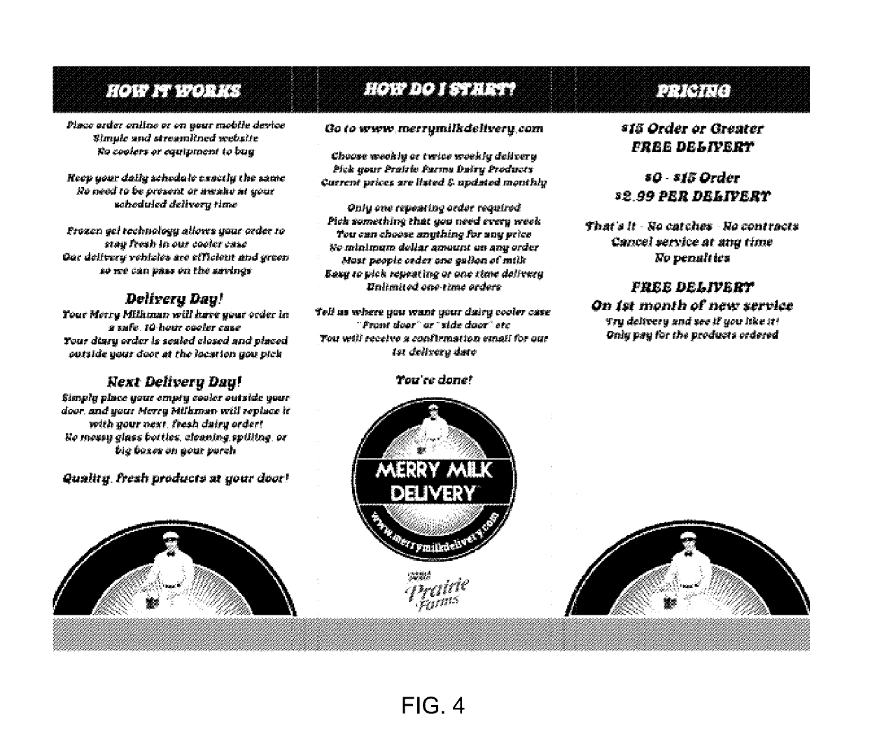

As explained in the brochure illustration of FIG. 4, the system works by providing an online ordering system. A customer can place an order online through a web site, or on the customer's mobile device. The website is simple and streamlined, and there are no coolers or equipment to buy.

The customer can keep their daily schedule exactly the same since there is no need to be present or awake at your scheduled delivery time. Frozen gel technology allows an order to stay fresh in the cooler case, and delivery vehicles are efficient and green so that the system allows savings to pass on to customers. On the delivery day, the delivery person will have the order in a safe, 10 hour cooler case that will keep the products cool for the 10 hour period. The delivery order is sealed closed and placed outside the customer door at the location picked by the customer.

On the next delivery day, the customer need only simply place the empty cooler outside the customer's door, and the delivery person will replace the empty cooler with the next, fresh product order in a new cooler filled with the next product order. This results in no messy glass bottles, cleaning, spilling or big boxes on the customer's porch. This system results in quality, fresh products delivered to the customer's door.

The web site is configured so that the customer can start the ordering process. The customer will choose weekly or twice weekly delivery, and also pick the available products at the current prices listed on the web site. The prices may be updated periodically, such as monthly. The system may only require one repeating order. Basically, the customer would pick something that they need every week, and the customer can choose any product for any price that is available. There is no minimum dollar amount on any order. For example, most people may order one gallon of milk, where it is easy to pick repeating or one time delivery. The customer may have unlimited one-time orders.

The customer also specifies where they want the product or dairy cooler case such as, for example, the front door, side door, etc. The system will send and the customer will receive a confirmation e-mail of the first delivery date. The delivery fees may be some amount such as $2.99 per delivery for orders between $0-$15 and free delivery for a $15 order or greater. This system has no other hidden requirements or contracts and a customer can cancel service at any time with no penalties. The system may also provide for free delivery on the 1^{st} month of new service, wherein the customer can try delivery and see if they like it. The customer only pays for products that they ordered.

Although a particular preferred system and method of the invention has been disclosed in detail for illustrative purposes, it will be recognized that variations or modifications of the disclosed apparatus, including the rearrangement of parts, lie within the scope of the present invention.

What is claimed:

1. A delivery system for perishable products, comprising the steps of:
providing a website serving as a sales platform for the delivery system, said website having communications links with remote customers to allow customers to access said website and place orders by entering ordering information including product information and delivery information for said products;
said website being capable of receiving said ordering information including customer name, delivery address, product information, and delivery schedule;
providing a facility in a distribution territory which comprises a cooler which permits storage of said products, and a refrigeration unit which permits storage and cooling of cooler cases which permit storage of a quantity of said products therein at a cooled temperature;
said facility receiving said products from said distributors which are then stored in said cooler;
packaging said cases with a quantity of said products corresponding to an order for one said delivery address;
prior to said packaging of said cases, storing said cases in said refrigeration unit until said cases are cooled to a temperature which keeps said products when packaged in said cases at a cooled temperature to permit delivery to delivery addresses;
generating labels for said cases containing delivery information associated with said ordering information and placing said labels on said cooler cases in preparation for delivery;
providing a delivery vehicle comprising an electric vehicle having a maximum carrying capacity defined the maximum number of said cooler cases which are storable therein, said delivery vehicle being loaded with a quantity of said cooler cases for delivery over a delivery route travelled by said delivery vehicle;
said delivery vehicle having a driver with a computer-based mobile device receiving delivery information for said cooler cases stored in said delivery vehicle including delivery addresses associated with said labels, and said delivery route to effect delivery of said cooler cases to said delivery addresses; and
delivering said cooler cases to said residence addresses along said delivery route.

2. The system according to claim 1, wherein said system receives said orders received and plots said residence addresses on a GPS enabled map.

3. The system according to claim 1, wherein each of said labels placed on each said cooler case identifies the order to deliver at said delivery address associated with said order.

4. The system according to claim 1, wherein eat each of said delivery addresses, said driver exchange a packaged one of said cooler cases with an empty one of said cooler cases which had been previously delivered to said delivery address and emptied by said customer.

5. The system according to claim 4, wherein said customer places the empty cooler case outside said delivery address for pickup by said driver on a next delivery day.

6. The system according to claim 5, wherein when said packaged cooler case is exchanged with said empty cooler case at said delivery address, said driver marks the delivery as complete on said mobile device, which communicates with said sales platform.

7. The system according to claim 6, wherein marking of said delivery as complete causes said sales platform to notify the customer of the delivery arrival via a communication link between said sales platform and a mobile device used by said customer.

8. The system according to claim 4, wherein said driver travels said delivery route and exchanges said packaged cooler cases with said empty cooler cases left by said customers at said delivery address, and said driver finally returns to said facility with said empty cooler cases.

9. The system according to claim 8, wherein said empty cooler cases are placed into the refrigeration unit for cooling in preparation for repackaging with said products and delivery at a subsequent delivery time.

10. The system according to claim 9, wherein said process repeats the steps over subsequent delivery times with each said delivery address repetitively exchanging said empty cooler cases with said packaging cooler cases to receive new quantities of said products during each of said delivery times.
